(19) United States
(12) Patent Application Publication
(10) Pub. No.: US 2009/0085559 A1
(43) Pub. Date: Apr. 2, 2009

(54) SYSTEM AND METHOD FOR MINIMIZING ELECTROMAGNETIC FIELD DISTORTION IN AN ELECTROMAGNETIC TRACKING SYSTEM

(75) Inventor: Peter Traneus Anderson, Andover, MA (US)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 11/865,776

(22) Filed: Oct. 2, 2007

(51) Int. Cl. G01B 11/14

(52) U.S. Cl. 324/207.22

(57) ABSTRACT

A system and method of minimizing the electromagnetic field distortion in an electromagnetic tracking system. The system and method comprising a transmitter or receiver coil arrangement comprising at least two coils connected in series and symmetrically about opposite ends of an object to be tracked. The object to be tracked may be a medical device, implant or instrument that may be made of a magnetic field distorting electrically conductive material.

### BACKGROUND OF THE INVENTION

This disclosure relates generally to an electromagnetic tracking system that uses electromagnetic fields to determine the position and orientation of an object, and more particularly to a system and method for minimizing electromagnetic field distortion in an electromagnetic tracking system.

Electromagnetic tracking systems have been used in various industries and applications to provide position and orientation information relating to objects. For example, electromagnetic tracking systems may be useful in aviation applications, motion sensing applications, retail applications, and medical applications. In medical applications, electromagnetic tracking systems have been used to provide an operator (e.g., a physician, surgeon, or other medical practitioner) with information to assist in the precise and rapid positioning of a medical device or instrument located in or near a patient's body during image-guided surgery. An electromagnetic tracking system provides positioning and orientation information for a medical device or instrument with respect to the patient or a reference coordinate system. An electromagnetic tracking system provides intraoperative tracking of the precise location of a medical device or instrument in relation to multidimensional images of a patient's anatomy.

An electromagnetic tracking system uses visualization tools to provide a medical practitioner with co-registered views of a graphical representation of the medical device or instrument with pre-operative or intraoperative images of the patient's anatomy. In other words, an electromagnetic tracking system allows a medical practitioner to visualize the patient's anatomy and track the position and orientation of a medical device or instrument with respect to the patient's anatomy. As the medical device or instrument is positioned with respect to the patient's anatomy, the displayed image is continuously updated to reflect the real-time position and orientation of the medical device or instrument. The combination of the image and the representation of the tracked medical device or instrument provide position and orientation information that allows a medical practitioner to manipulate a medical device or instrument to a desired location with an accurate position and orientation.

Generally, an electromagnetic tracking system may include an electromagnetic transmitter with an array of one or more transmitter coils, an electromagnetic receiver with an array of one or more receiver coils, electronics to generate a current drive signal for the one or more transmitter coils and to measure the mutual inductances between transmitter and receiver coils, and a computer to calculate the position and orientation of the receiver coil array with the respect to the transmitter coil array, or vice versa. An alternating current drive signal is provided to each coil of the electromagnetic transmitter, generating an electromagnetic field being emitted from each coil of the electromagnetic transmitter. The electromagnetic field generated by each coil in the electromagnetic transmitter induces a voltage in each coil of the electromagnetic receiver. These voltages are indicative of the mutual inductances between the coils of the electromagnetic transmitter and the coils of the electromagnetic receiver. These voltages and mutual inductances are sent to a computer for processing. The computer uses these measured voltages and mutual inductances to calculate the position and orientation of the coils of the electromagnetic transmitter relative to the coils of the electromagnetic receiver, or the coils of the electromagnetic receiver relative to the coils of the electromagnetic transmitter, including six degrees of freedom (x, y, and z measurements, as well as roll, pitch and yaw angles).

Preferably, the mutual inductances between coils of the electromagnetic transmitter and the electromagnetic receiver may be measured without inaccuracies. However, electromagnetic tracking systems are known to suffer from accuracy degradation due to electromagnetic field distortion caused by the presence of an uncharacterized metal distorter within the tracking volume or electromagnetic fields of the electromagnetic tracking system. The presence of an uncharacterized metal distorter within the tracking volume of the electromagnetic tracking system may create distortion of the electromagnetic fields of the electromagnetic tracking system. This distortion may cause inaccuracies in tracking the position and orientation of medical devices and instruments by causing inaccuracies in position and orientation calculations of the coils of the electromagnetic transmitter relative to the coils of the electromagnetic receiver, or the coils of the electromagnetic receiver relative to the coils of the electromagnetic transmitter.

Therefore, there is a need for a system and method of minimizing the electromagnetic field distortion in an electromagnetic tracking system.

### BRIEF DESCRIPTION OF THE INVENTION

In an embodiment, an electromagnetic tracking system comprising at least one transmitter assembly coupled to an object to be tracked, the at least one transmitter assembly including at least two coils connected in series and located at opposite ends of the object to be tracked; at least one receiver assembly communicating with and receiving signals from the at least one transmitter assembly, the at least one receiver assembly including at least one coil; and electronics coupled to and communicating with the at least one transmitter assembly and the at least one receiver assembly for calculating the position and orientation of the object to be tracked.

In an embodiment, an electromagnetic tracking system comprising at least one transmitter assembly including at least one coil; at least one receiver assembly coupled to an object to be tracked, the at least one receiver assembly including at least two coils connected in series and located at opposite ends of the object to be tracked, the at least one receiver assembly communicating with and receiving signals from the at least one transmitter assembly; and electronics coupled to and communicating with the at least one transmitter assembly and the at least one receiver assembly for calculating the position and orientation of the object to be tracked.

In an embodiment, a transmitter coil array for an electromagnetic tracking system comprising at least two coils connected in series and located at opposite ends of an object to be tracked.

In an embodiment, a receiver coil array for an electromagnetic tracking system comprising at least two coils connected in series and located at opposite ends of an object to be tracked.

In an embodiment, a low distortion coil arrangement for an electromagnetic tracking system comprising at least one first coil attached to a side of an object to be tracked; and at least one second coil connected in series with the at least one first coil and attached to an opposite side of the object to be tracked.

In an embodiment, a method of minimizing the electromagnetic field distortion in an electromagnetic tracking system comprising attaching at least one coil to a side of an object to be tracked; attaching at least one coil to an opposite side of the object to be tracked; and determining the position and orientation of the object to be tracked.

Various other features, objects, and advantages of the invention will be made apparent to those skilled in the art from the accompanying drawings and detailed description thereof.

### BRIEF DESCRIPTION OF THE DRAWINGS

FIG. 1 is a block diagram illustrating an exemplary embodiment of an electromagnetic tracking system;

FIG. 2 is a block diagram illustrating an exemplary embodiment of an electromagnetic tracking system;

FIG. 3 is a schematic diagram illustrating an exemplary embodiment of an electromagnetic transmitter or receiver coil arrangement for an electromagnetic tracking system and the magnetic field surrounding the current carrying coils;

FIG. 4 is a schematic diagram illustrating an exemplary embodiment of an electromagnetic transmitter or receiver coil arrangement for an electromagnetic tracking system and the magnetic field surrounding the current carrying coils; and

FIG. 5 is a flow diagram illustrating an exemplary embodiment of a method of minimizing the electromagnetic field distortion in an electromagnetic tracking system.

### DETAILED DESCRIPTION OF THE INVENTION

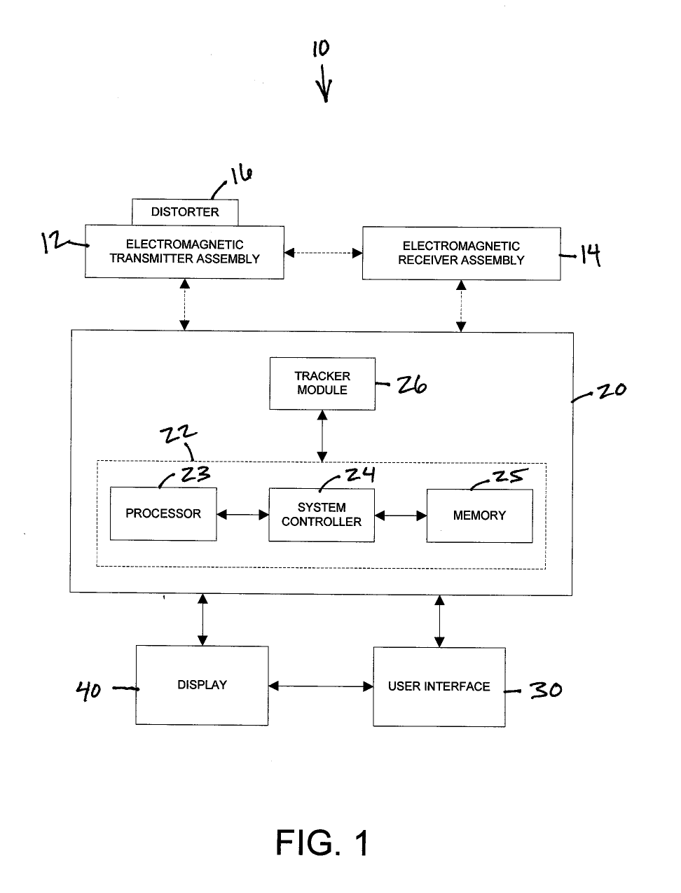

Referring now to the drawings, FIG. 1 is a block diagram illustrating an exemplary embodiment of an electromagnetic tracking system 10. The electromagnetic tracking system 10 comprises at least one electromagnetic transmitter assembly 12 with one or more transmitter coils and at least one electromagnetic receiver assembly 14 with one or more receiver coils. The transmitter or receiver coils are configured to minimize the magnetic field distortion in an electromagnetic tracking system. The electromagnetic tracking system 10 provides position and orientation data that spatially relates the receiver coils to the transmitter coils, or vice versa.

FIG. 1 also illustrates at least one distorter 16 coupled or attached to the at least one electromagnetic transmitter assembly 12 and within the tracking volume of the electromagnetic tracking system 10. The attachment of the at least one electromagnetic transmitter assembly 12 to the at least one distorter 16 allows tracking of the at least one distorter 16 during a tracking procedure. The at least one distorter 16 may be a medical device, implant or instrument that may be made of a magnetic field distorting electrically conductive material. The at least one distorter 16 may distort the magnetic fields being generated by the coils of the electromagnetic transmitter assembly 12, and thus skew the position and orientation of the distorter 16 (medical device, implant or instrument) being tracked. The magnetic field measurements are used to calculate the position and orientation of the at least one electromagnetic transmitter assembly 12 with respect to the at least one electromagnetic receiver assembly 14 according to any suitable method or system.

The electromagnetic tracking system 10 further comprises a tracker workstation 20 coupled to and receiving data from the at least one electromagnetic transmitter assembly 12 and the at least one electromagnetic receiver assembly 14, a user interface 30 coupled to the tracker workstation 20, and a display 40 for visualizing imaging and tracking data. The tracker workstation 20 includes a tracking system computer 22 and a tracker module 26. The tracking system computer 22 includes at least one processor 23, a system controller 24 and memory 25.

The coils of the electromagnetic transmitter and receiver assemblies 12, 14 may be built with various coil architectures. The one or more coils of the electromagnetic transmitter assembly 12 may be single coils, a pair of single coils, industry-standard-coil-architecture (ISCA) type coils, a pair of ISCA type coils, multiple coils, or an array of coils. The one or more coils of the electromagnetic receiver assembly 14 may be single coils, a pair of single coils, ISCA type coils, a pair of ISCA type coils, multiple coils, or an array of coils.

ISCA type coils are defined as three approximately collocated, approximately orthogonal, and approximately dipole coils. Therefore, ISCA electromagnetic transmitter and receiver coils would include three approximately collocated, approximately orthogonal, and approximately dipole coils for the transmitter assembly and three approximately collocated, approximately orthogonal, and approximately dipole coils for the receiver assembly. In other words, an ISCA configuration for the electromagnetic transmitter and receiver assemblies would include a three-axis dipole coil transmitter and a three-axis dipole coil receiver. In the ISCA configuration, the transmitter coils and the receiver coils are configured such that the three coils (i.e., coil trios) exhibit the same effective area, are oriented orthogonally to one another, and are centered at the same point.

In an exemplary embodiment, the coils of the at least one electromagnetic transmitter assembly 12 may be characterized as single dipole coils and emit magnetic fields when a current is passed through the coils. Those skilled in the art will appreciate that multiple electromagnetic field generating coils may be used in coordination to generate multiple magnetic fields. Similar to the at least one electromagnetic transmitter assembly 12, the coils of the at least one electromagnetic receiver assembly 14 may be characterized as single dipole coils and detect the magnetic fields emitted by the at least one electromagnetic transmitter assembly 12. When a current is applied to the coils of the at least one electromagnetic transmitter assembly 12, the magnetic fields generated by the coils may induce a voltage into each coil of the at least one electromagnetic receiver assembly 14. The induced voltage is indicative of the mutual inductance between the one or more coils of the at least one electromagnetic transmitter assembly 12. Thus, the induced voltage across each coil of the at least one electromagnetic receiver assembly 14 is detected and processed to determine the mutual inductance between each coil of the at least one electromagnetic transmitter assembly 12 and each coil of the at least one electromagnetic receiver assembly 14.

The magnetic field measurements may be used to calculate the position and orientation of the at least one electromagnetic transmitter assembly 12 with respect to the at least one electromagnetic receiver assembly 14, or vice versa according to any suitable method or system. The detected magnetic field measurements are digitized by electronics that may be included with the at least one electromagnetic receiver assembly 14 or the tracker module 26. The magnetic field measurements or digitized signals may be transmitted from the at least one electromagnetic receiver assembly 14 to the tracking system computer 22 using wired or wireless communication protocols and interfaces. The digitized signals received by the tracking system computer 22 represent magnetic field information detected by the at least one electromagnetic receiver assembly 14. The digitized signals are used to calculate position and orientation information of the at least one electromagnetic transmitter assembly 12 or the at least one electromagnetic receiver assembly 14.

The position and orientation information is used to register the location of the at least one electromagnetic receiver assembly 14 or the at least one electromagnetic transmitter assembly 12 to acquired imaging data from an imaging system. The position and orientation data is visualized on the display 40, showing in real-time the location of the at least one electromagnetic transmitter assembly 12 or the at least one electromagnetic receiver assembly 14 on pre-acquired or real-time images from the imaging system. The acquired imaging data may be from a computed tomography (CT) imaging system, a magnetic resonance (MR) imaging system, a positron emission tomography (PET) imaging system, an ultrasound imaging system, an X-ray imaging system, or any suitable combination thereof. All six degrees of freedom (three of position (x, y, z) and three of orientation (roll, pitch, yaw)) of the at least one electromagnetic receiver assembly 14 or the at least one electromagnetic transmitter assembly 12 may be determined and tracked.

In an exemplary embodiment, the one or more coils of the electromagnetic transmitter and receiver assemblies 12, 14 are either precisely manufactured or precisely characterized during manufacture to obtain mathematical models of the one or more coils in the electromagnetic transmitter and receiver assemblies 12, 14. From the magnetic field measurements and mathematical models of the one or more coils, the position and orientation of the at least one electromagnetic receiver assembly 14 with respect to the at least one electromagnetic transmitter assembly 12 may be determined. Alternatively, the position and orientation of the at least one electromagnetic transmitter assembly 12 with respect to the at least one electromagnetic receiver assembly 14 may be determined.

In an exemplary embodiment, the at least one electromagnetic transmitter assembly 12 may be a battery-powered wireless transmitter assembly, a passive transmitter assembly, or a wired transmitter assembly. In an exemplary embodiment, the at least one electromagnetic receiver assembly 14 may be a battery-powered wireless receiver assembly, a passive receiver assembly, or a wired receiver assembly.

In an exemplary embodiment, the at least one electromagnetic transmitter assembly 12 may be attached to a medical device, implant or instrument to be tracked and the at least one electromagnetic receiver assembly 14 may be positioned within the at least one electromagnetic field generated by the at least one electromagnetic transmitter assembly 12.

In an exemplary embodiment, the at least one electromagnetic receiver assembly 14 may be attached to a medical device, implant or instrument to be tracked and the at least one electromagnetic transmitter assembly 12 may be positioned to generate at least one electromagnetic field receivable by the at least one electromagnetic receiver assembly 14.

In an exemplary embodiment, the tracker module 26 may include drive circuitry configured to provide a drive current to each coil of the at least one electromagnetic transmitter assembly 12. By way of example, a drive current may be supplied by the drive circuitry to energize a coil of the at least one electromagnetic transmitter assembly 12, and thereby generate an electromagnetic field that is detected by a coil of the at least one electromagnetic receiver assembly 14. The drive current may be comprised of a periodic waveform with a given frequency (e.g., a sine wave, cosine wave or other periodic signal). The drive current supplied to a coil will generate an electromagnetic field at the same frequency as the drive current. The electromagnetic field generated by a coil of the at least one electromagnetic transmitter assembly 12 induces a voltage indicative of the mutual inductance in a coil of the at least one electromagnetic receiver assembly 14. In an exemplary embodiment, the tracker module 26 may include receiver data acquisition circuitry for receiving voltage and mutual inductance data from the at least one electromagnetic receiver assembly 14.

In an exemplary embodiment, the tracking system computer 22 may include at least one processor 23, such as a digital signal processor, a CPU, or the like. The processor 23 may process measured voltage and mutual inductance data from the at least one electromagnetic receiver assembly 14 to track the position and orientation of the at least one electromagnetic transmitter assembly 12 or the at least one electromagnetic receiver assembly 14.

The at least one processor 23 may implement any suitable algorithm(s) to use the measured voltage signal indicative of the mutual inductance to calculate the position and orientation of the at least one electromagnetic receiver assembly 14 relative to the at least one electromagnetic transmitter assembly 12, or the at least one electromagnetic transmitter assembly 12 relative to the at least one electromagnetic receiver assembly 14. For example, the at least one processor 23 may use ratios of mutual inductance between each coil of the at least one electromagnetic receiver assembly 14 and each coil of the at least one electromagnetic transmitter assembly 12 to triangulate the relative positions of the coils. The at least one processor 23 may then use these relative positions to calculate the position and orientation of the at least one electromagnetic transmitter assembly 12 or the at least one electromagnetic receiver assembly 14.

In an exemplary embodiment, the tracking system computer 22 may include a system controller 24. The system controller 24 may control operations of the electromagnetic tracking system 10.

In an exemplary embodiment, the tracking system computer 22 may include memory 25, which may be any processor-readable media that is accessible by the components of the tracker workstation 20. In an exemplary embodiment, the memory 25 may be either volatile or non-volatile media. In an exemplary embodiment, the memory 25 may be either removable or non-removable media. Examples of processor-readable media may include (by way of example and not limitation): RAM (Random Access Memory), ROM (Read Only Memory), registers, cache, flash memory, storage devices, memory sticks, floppy disks, hard drives, CD-ROM, DVD-ROM, network storage, and the like.

In an exemplary embodiment, the user interface 30 may include devices to facilitate the exchange of data and workflow between the system and the user. In an exemplary embodiment, the user interface 30 may include a keyboard, a mouse, a joystick, buttons, a touch screen display, or other devices providing user-selectable options, for example. In an exemplary embodiment, the user interface 30 may also include a printer or other peripheral devices.

In an exemplary embodiment, the display 40 may be used for visualizing the position and orientation of a tracked object with respect to a processed image from an imaging system.

In an exemplary embodiment, the at least one electromagnetic receiver assembly 14 may be attached to a medical device, implant or instrument 16 to be tracked and the at least one electromagnetic transmitter assembly 12 may generate at least one electromagnetic field to be received by the at least one electromagnetic receiver assembly 14. The electromagnetic tracking system 10, may track the position and orientation of the medical device, implant or instrument 16 during a medical procedure.

In an exemplary embodiment, the at least one electromagnetic transmitter assembly 12 may be attached to a medical device, implant or instrument 16 to be tracked and the at least one electromagnetic receiver assembly 14 may be positioned within at least one electromagnetic field generated by the at least one electromagnetic transmitter assembly 12. The electromagnetic tracking system 10 enables a medical professional to continually track the position and orientation of the medical device, implant or instrument 16 during a medical procedure.

In an exemplary embodiment, the at least one electromagnetic transmitter and receiver assemblies 12, 14 may be wireless, with the coils being driven self-contained circuitry, data acquisitions being performed by self-contained circuitry, and power being provided by a self-contained power source.

Notwithstanding the description of the exemplary embodiment of the electromagnetic tracking system 10 illustrated FIG. 1, alternative system architectures may be substituted without departing from the scope of the invention.

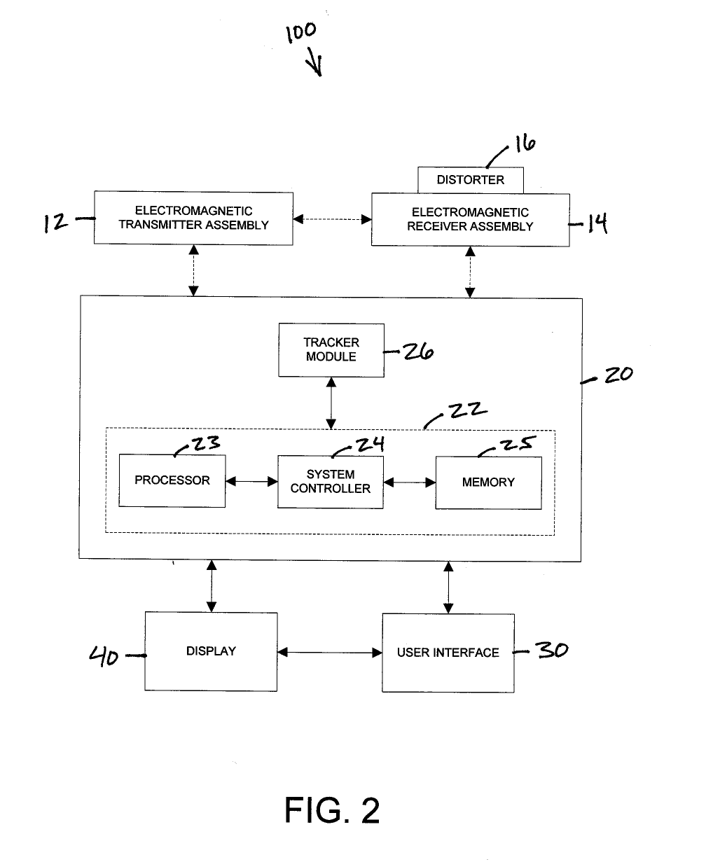

FIG. 2 is a block diagram illustrating an exemplary embodiment of an electromagnetic tracking system 100. FIG. 2 is similar to the schematic diagram of the electromagnetic tracking system 10 of FIG. 1, except that it shows the at least one distorter 16 (medical device, implant or instrument) coupled or attached to the at least one electromagnetic receiver assembly 14 and within the tracking volume of the electromagnetic tracking system 100. This is a different configuration for tracking the position and orientation of the at least one electromagnetic receiver assembly 14 with respect to the at least one electromagnetic transmitter assembly 12 according to any suitable method or system.

The attachment of the at least one electromagnetic receiver assembly 14 to the at least one distorter 16 allows tracking of the at least one distorter 16 during a tracking procedure. The at least one distorter 16 may be a medical device, implant or instrument that may be made of an electromagnetic field distorting electrically conductive material. The at least one distorter 16 may distort the magnetic fields being generated by the coils of the electromagnetic transmitter assembly 12, and thus skew the position and orientation of the distorter 16 (medical device, implant or instrument) being tracked. The magnetic field measurements are used to calculate the position and orientation of the at least one electromagnetic receiver assembly 14 with respect to the at least one electromagnetic transmitter assembly 12 according to any suitable method or system.

In an exemplary embodiment, the at least one electromagnetic receiver assembly 14 may be attached to a medical device, implant or instrument 16 to be tracked and the at least one electromagnetic transmitter assembly 12 may generate at least one electromagnetic field to be received by the at least one electromagnetic receiver assembly 14. The electromagnetic tracking system 100 enables a medical professional to continually track the position and orientation of the medical device, implant or instrument 16 during a medical procedure.

Notwithstanding the description of the exemplary embodiment of the electromagnetic tracking system 100 illustrated FIG. 2, alternative system architectures may be substituted without departing from the scope of the invention.

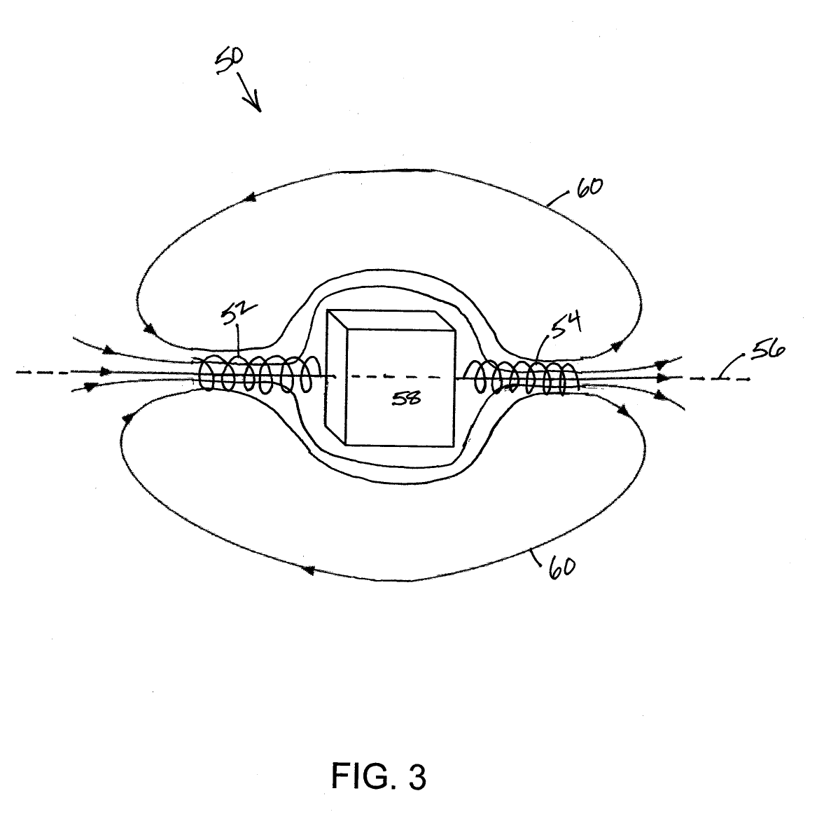

FIG. 3 is a schematic diagram illustrating an exemplary embodiment of an electromagnetic transmitter or receiver coil arrangement 50 for an electromagnetic tracking system. The electromagnetic transmitter or receiver coil arrangement 50 provides a low distortion coil set that includes a set of two coils, a first coil 52 and a second coil 54, connected in series and positioned symmetrically about a longitudinal axis 56 at opposite ends of an object 58 to be tracked. The mechanical symmetry and positioning of the first coil 52 and the second coil 54 about object 58 minimizes the electromagnetic distortion that may be caused by the potentially distorting object 58.

In an exemplary embodiment, the object 58 to be tracked may be a distorter made of an electromagnetic field distorting electrically conductive material that may distort the magnetic field and render the position and orientation calculations of the object 58 to be tracked inaccurate. Electrically conductive materials in the vicinity of electromagnetic transmitter or receiver assemblies, may distort the magnetic fields generated by the coils of at least one electromagnetic transmitter assembly and received by at least one electromagnetic receiver assembly. This may lead to inaccurate position and orientation calculations of an object being tracked. In an exemplary embodiment, the object 58 to be tracked may be a medical device, implant or instrument.

FIG. 3 also illustrates the magnetic field 60 created by the electromagnetic transmitter or receiver coil arrangement 50. In the case of a transmitter assembly, a drive current is applied to the first coil 52 and the second coil 54. The drive current may comprise a periodic waveform of a given frequency (e.g., a sine wave, cosine wave or other periodic signal). The drive current applied to the first coil 52 may be the same as or different from the drive current applied to the second coil 54. The drive current supplied to the first and second coils generates a magnetic field at the same frequency as the drive current. A magnetic field 60 is formed around the first 52 and second 54 coils with the object 58 to be tracked inbetween. The magnetic field 60 travels from the first coil 52 around the object 58 to be tracked to the second coil 54. The magnetic field 60 travels around the object 58 to get from the first coil 52 to the second coil 54. The magnetic field 60 travels through the center of the first coil 52 along a longitudinal axis 56, travels around the object 58 to be tracked through the center of the second coil 54 along the longitudinal axis 56, and circles back around the outside of the second coil 54 to the first coil 52. There is no magnetic field distortion at the center of the object 58 to be tracked.

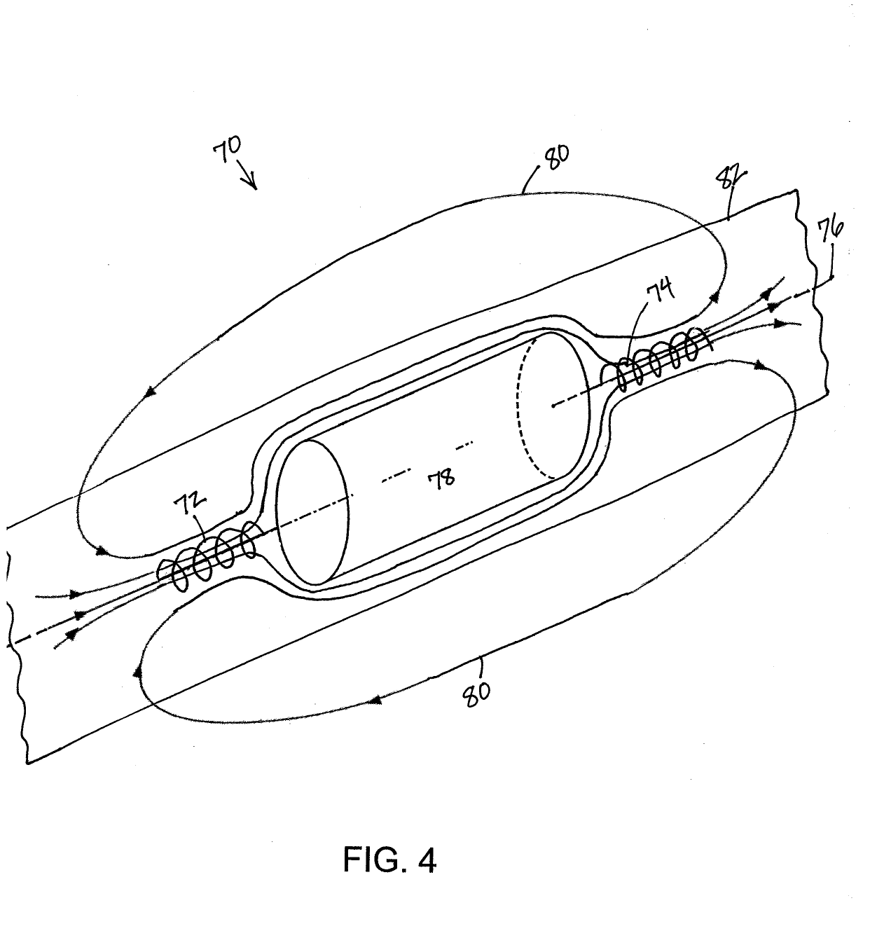

FIG. 4 is a schematic diagram illustrating an exemplary embodiment of an electromagnetic transmitter or receiver coil arrangement 70 for an electromagnetic tracking system. The electromagnetic transmitter or receiver coil arrangement 70 provides a low distortion coil set that includes a set of two coils, a first coil 72 and a second coil 74, connected in series and positioned symmetrically about a longitudinal axis 76 at opposite ends of an object 78 to be tracked. The mechanical symmetry and positioning of the first coil 72 and the second coil 74 about object 78 minimizes the electromagnetic distortion that may be caused by the potentially distorting object 78.

In an exemplary embodiment, the object 78 to be tracked may be a distorter made of an electromagnetic field distorting electrically conductive material that may distort the magnetic field and render the position and orientation calculations of the object 78 to be tracked inaccurate. Electrically conductive materials in the vicinity of electromagnetic transmitter or receiver assemblies, may distort the magnetic fields generated by the coils of at least one electromagnetic transmitter assembly and received by at least one electromagnetic receiver assembly. This may lead to inaccurate position and orientation calculations of an object being tracked. In an exemplary embodiment, the object 78 to be tracked may be a medical device, implant or instrument.

FIG. 4 also illustrates the magnetic field 80 created by the electromagnetic transmitter or receiver coil arrangement 70. In the case of a transmitter assembly, a drive current is applied to the first coil 72 and the second coil 74. The drive current may comprise a periodic waveform of a given frequency (e.g., a sine wave, cosine wave or other periodic signal). The drive current applied to the first coil 72 may be the same as or different from the drive current applied to the second coil 74. The drive current supplied to the first and second coils generates a magnetic field at the same frequency as the drive current. A magnetic field 80 is formed around the first 72 and second 74 coils with the object 78 to be tracked inbetween. The magnetic field 80 travels from the first coil 72 around the object 78 to be tracked to the second coil 74. The magnetic field 80 travels around the object 78 to get from the first coil 72 to the second coil 74. The magnetic field 80 travels through the center of the first coil 72 along a longitudinal axis 76, travels around the object 78 to be tracked through the center of the second coil 74 along the longitudinal axis 76, and circles back around the outside of the second coil 74 to the first coil 72. There is no magnetic field distortion at the center of the object 78 to be tracked.

In an exemplary embodiment, the electromagnetic transmitter or receiver coil arrangement 70 may be enclosed within a housing 82. The housing 82 provides for rigidly mounting the set of two coils 72, 74 to the object 78 to be tracked. The housing 82 may take the form of an enclosure coupled to the body of the object 78 to be tracked, such as a medical device, implant or instrument.

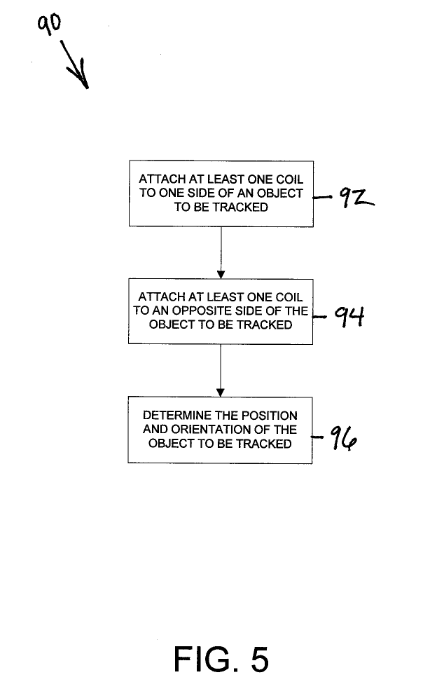

FIG. 5 is a flow diagram illustrating an exemplary embodiment of a method 90 of minimizing the electromagnetic field distortion in an electromagnetic tracking system. The method 90 comprises attaching at least one coil to one side of an object to be tracked 92. Attaching at least one coil to an opposite side of the object to be tracked 94. The coils attached to opposite ends of the object to be tracked are connected in series and positioned symmetrically about a longitudinal axis at opposite ends of the object to be tracked. The mechanical symmetry and positioning of the coils attached to opposite ends of the object to be tracked minimizes the electromagnetic distortion that may be caused by the potentially distorting object. The position and orientation of the object to be tracked is determined by the electromagnetic tracking system 96.

In determining the position and orientation of the object to be tracked, a drive current is applied to the coil(s) of a transmitter assembly. Measurements are taken of the magnetic field(s) generated by the transmitter assembly and received by a receiver assembly. The magnetic field measurements are used to calculate the position and orientation of the object to be tracked according to any suitable method or system.

In an exemplary embodiment, the object to be tracked is a medical device, implant or instrument that is made of a magnetic field distorting electrically conductive material.

Several embodiments are described above with reference to drawings. These drawings illustrate certain details of exemplary embodiments that implement the systems, methods and computer programs of this disclosure. However, the drawings should not be construed as imposing any limitations associated with features shown in the drawings.

Certain embodiments may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the system might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

While the invention has been described with reference to various embodiments, those skilled in the art will appreciate that certain substitutions, alterations and omissions may be made to the embodiments without departing from the spirit of the invention. Accordingly, the foregoing description is meant to be exemplary only, and should not limit the scope of the disclosure as set forth in the following claims.

What is claimed is:

1. An electromagnetic tracking system comprising:
at least one transmitter assembly coupled to an object to be tracked, the at least one transmitter assembly including at least two coils connected in series and located at opposite ends of the object to be tracked;
at least one receiver assembly communicating with and receiving signals from the at least one transmitter assembly, the at least one receiver assembly including at least one coil; and
electronics coupled to and communicating with the at least one transmitter assembly and the at least one receiver assembly for calculating the position and orientation of the object to be tracked.

2. The electromagnetic tracking system of claim 1, wherein the at least two coils of the at least one transmitter assembly are positioned symmetrically about a longitudinal axis at opposite ends of the object to be tracked.

3. The low distortion coil arrangement of claim 1, wherein the object to be tracked is a medical device, implant or instrument that is made of a magnetic field distorting electrically conductive material.

4. An electromagnetic tracking system comprising:
at least one transmitter assembly including at least one coil;
at least one receiver assembly coupled to an object to be tracked, the at least one receiver assembly including at least two coils connected in series and located at opposite ends of the object to be tracked, the at least one receiver assembly communicating with and receiving signals from the at least one transmitter assembly; and
electronics coupled to and communicating with the at least one transmitter assembly and the at least one receiver assembly for calculating the position and orientation of the object to be tracked.

5. The electromagnetic tracking system of claim 4, wherein the at least two coils of the at least one transmitter assembly are positioned symmetrically about a longitudinal axis at opposite ends of the object to be tracked.

6. The electromagnetic tracking system of claim 4, wherein the object to be tracked is a medical device, implant or instrument that is made of a magnetic field distorting electrically conductive material.

7. A transmitter coil array for an electromagnetic tracking system comprising at least two coils connected in series and located at opposite ends of an object to be tracked.

8. The transmitter coil array of claim 7, wherein the at least one first coil and the at least one second coil are positioned symmetrically about a longitudinal axis at opposite ends of the object to be tracked.

9. The transmitter coil array of claim 7, wherein the object to be tracked is a medical device, implant or instrument that is made of a magnetic field distorting electrically conductive material.

10. A receiver coil array for an electromagnetic tracking system comprising at least two coils connected in series and located at opposite ends of an object to be tracked.

11. The receiver coil array of claim 10, wherein the at least one first coil and the at least one second coil are positioned symmetrically about a longitudinal axis at opposite ends of the object to be tracked.

12. The receiver coil array of claim 10, wherein the object to be tracked is a medical device, implant or instrument that is made of a magnetic field distorting electrically conductive material.

13. A low distortion coil arrangement for an electromagnetic tracking system comprising:
at least one first coil attached to a side of an object to be tracked; and
at least one second coil connected in series with the at least one first coil and attached to an opposite side of the object to be tracked.

14. The low distortion coil arrangement of claim 13, wherein the at least one first coil and the at least one second coil are positioned symmetrically about a longitudinal axis at opposite ends of the object to be tracked.

15. The low distortion coil arrangement of claim 13, wherein the low distortion coil arrangement is for a transmitter assembly.

16. The low distortion coil arrangement of claim 13, wherein the low distortion coil arrangement is for a receiver assembly.

17. The low distortion coil arrangement of claim 13, wherein the object to be tracked is a medical device, implant or instrument that is made of a magnetic field distorting electrically conductive material.

18. A method of minimizing the electromagnetic field distortion in an electromagnetic tracking system comprising:
attaching at least one coil to a side of an object to be tracked;
attaching at least one coil to an opposite side of the object to be tracked; and
determining the position and orientation of the object to be tracked.

19. The method of claim 18, wherein the coils attached to opposite ends of the object to be tracked are connected in series and positioned symmetrically about a longitudinal axis at opposite ends of the object to be tracked.

20. The method of claim 18, wherein the step of determining the position and orientation of the object to be tracked includes applying a drive current to at least one coil of a transmitter assembly, measuring the magnetic field generated by the at least one coil of the transmitter assembly and received by at least one coil of a receiver assembly, and using the magnetic field measurements to calculate the position and orientation of the object to be tracked

21. The method of claim 18, wherein the object to be tracked is a medical device, implant or instrument that is made of a magnetic field distorting electrically conductive material.
